(19) United States
(12) Patent Application Publication
(10) Pub. No.: US 2005/0141020 A1
(43) Pub. Date: Jun. 30, 2005

(54) Image-forming system, display-control method, storage medium storing computer-readable program, and program

(75) Inventor: Yuzo Harano, Sagamihara-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/996,158

(22) Filed: Nov. 22, 2004

(30) Foreign Application Priority Data
Dec. 3, 2003 (JP) 2003-404291

(51) Int. Cl. G06F 15/00

(52) U.S. Cl. 358/1.15; 358/448

(57) ABSTRACT

To achieve both convenience and security in performing a specific setting for an image-forming apparatus, identification information for identifying the apparatus together with a request for specific UI (user interface) data are sent to an external unit. Specific UI data stored in the external unit is obtained in order to generate and display an individual UI on a UI display of the image-forming apparatus based on the specific UI data obtained.

### BACKGROUND OF THE INVENTION

1. Field of the Invention

The present invention relates to an image-forming system, a display-control method, a storage medium storing a computer-readable program, and a program, wherein display control is executable. In the display control, user interface (UI) data for obtaining a UI to be displayed on an operation panel of an image-forming apparatus is requested and received from an external unit. In the image-forming system, one or a plurality of image-forming apparatuses and an external unit are connected such that they can communicate via a network.

2. Description of the Related Art

In a known UI (user interface) system related to maintenance, such as adjustments, whose items are displayed on an operation panel of an image-forming apparatus typified by printers and multi function printers (MFPs), UI data is prestored in the image-forming apparatus. Items to be displayed are classified according to control methods (see Japanese Patent Laid-Open No. 2000-298561).

In known UI systems structured as described above, it has been pointed out that maintenance-related items, which are not necessary or desirable for all the apparatuses and users, are displayed.

In markets such as the print on demand (POD) market, there is a need for flexible control of maintenance items, for example, adjustment of fuser temperature and the amount of toner deposition; therefore, they should be displayed depending on the apparatus and the maintenance operator.

Moreover, it is desired that a UI environment can be easily managed by apparatus manufacturers and system administrators for apparatus users, and be unified across the entire system.

### SUMMARY OF THE INVENTION

The present invention provides an image-forming system, a display-control method, a storage medium storing a computer-readable program, and a program that are capable of solving the problems described above.

Moreover, the present invention provides an image-forming system, a display-control method, a storage medium storing a computer-readable program, and a program that can achieve both convenience and security.

According to an aspect of the invention, an image-forming system in which at least one image-forming apparatus is connected to an external unit, via a network, such that they can communicate with one another is provided. Each image-forming apparatus includes: first user interface control means for displaying a local user interface on a display, based on local user interface data used for a setting required for predetermined image-forming processing; and second user interface control means for sending a user interface request for specific user interface data together with identification information for identifying the image-forming apparatus to the external unit, and generating and displaying an individual user interface on the display, based on the specific user interface data obtained from the external unit. The external unit includes: storing means for storing specific user interface data specific to each image-forming apparatus to uniquely identify each image-forming apparatus; and user interface data processing means for identifying the image-forming apparatus from which the user interface request is sent, extracting, from the storing means, the specific user interface data for the image-forming apparatus identified, and sending the specific user interface data for the image-forming apparatus to the image-forming apparatus requesting the specific user interface data.

According to another aspect of the invention, a display-control method in an image-forming system in which at least one image-forming apparatus is connected to an external unit including storing means for storing user interface data specific to each image-forming apparatus so as to be identifiable, via a network, such that they can communicate with one another is provided. The display-control method includes: displaying a local user interface on a display, based on local user interface data used for a setting required for predetermined image-forming processing; sending a request for specific user interface data together with identification information for identifying the image-forming apparatus to the external unit; generating and displaying an individual user interface on the display, based on the specific user interface data obtained from the external unit; identifying the image-forming apparatus from which a user interface request is sent; extracting the specific user interface data identified; and sending the specific user interface data to the image-forming apparatus requesting the specific user interface data.

According to another aspect of the present invention, a control method in a system having a second device capable of receiving data from a first device is provided. The control method includes: allowing information output from the first device and required for performing a specific setting related to the second device to be stored in a storage unit; and making the specific setting executable based on the information in the storage unit. The information is prohibited from remaining in the storage unit while the specific setting is not performed.

According to another aspect of the present invention, a system having a second device capable of receiving data from a first device is provided. The system includes: a storage controller adapted to allow information to be stored in a storage unit, the information being output from the first device and required for performing a specific setting related to the second device; and a setting controller adapted to make the specific setting executable based on the information in the storage unit. The information is prohibited from remaining in the storage unit while the specific setting is not performed.

According to yet another aspect of the present invention a system including an information processor and a plurality of image-forming apparatuses capable of performing data communication with the information processor is provided. Each image-forming apparatus includes: a storage unit; an information requesting unit adapted to send a request for information necessary for performing a specific setting to the information processor; an information receptor adapted to receive the information output from the information processor in response to the request; a storage controller adapted to allow the received information to be stored in the storage unit; and a setting controller adapted to make the specific setting executable based on the information in the storage unit. The storage controller prohibits the information from remaining in the storage unit while the specific setting is not performed.

According to still another aspect of the present invention, a method in a system including an information processor and a plurality of image-forming apparatuses capable of performing data communication with the information processor is provided. The method enables the plurality of image-forming apparatuses to execute steps including: sending a request for information necessary for performing a specific setting to the information processor; receiving the information output from the information processor in response to the request; allowing the received information to be stored in a storage unit of each image-forming apparatus; and making the specific setting executable based on the information in the storage unit. The information is prohibited from remaining in the storage unit while the specific setting is not performed.

Further features and advantages of the present invention will become apparent from the following description of exemplary embodiments with reference to the attached drawings.

### BRIEF DESCRIPTION OF THE DRAWINGS

FIG. 1 is an overall view showing the structure of an image-forming system according to a first embodiment of the present invention.

FIG. 2 is a diagram showing an example of an operation screen displayed on a UI display in FIG. 1.

FIG. 3 is a diagram showing an example of an operation screen displayed on the UI display in FIG. 1.

FIG. 4 is a diagram showing an example of an operation screen displayed on the UI display in FIG. 1.

FIG. 5 is a flowchart showing an example of a first data processing procedure in the image-forming system according to the present invention.

FIG. 6 is a diagram showing an example of a user authentication screen in an image-forming system according to a second embodiment of the present invention.

FIG. 7 is a flowchart showing an example of a second data processing procedure in the image-forming system according to the present invention.

FIG. 8 is a diagram illustrating a memory map of a storage medium storing a variety of data processing programs readable by an image-forming apparatus according to the present invention.

### DESCRIPTION OF THE EMBODIMENTS

Exemplary embodiments of the present invention are described below with reference to the drawings.

Detailed descriptions of the exemplary embodiments of the present invention are provided below.

First Embodiment

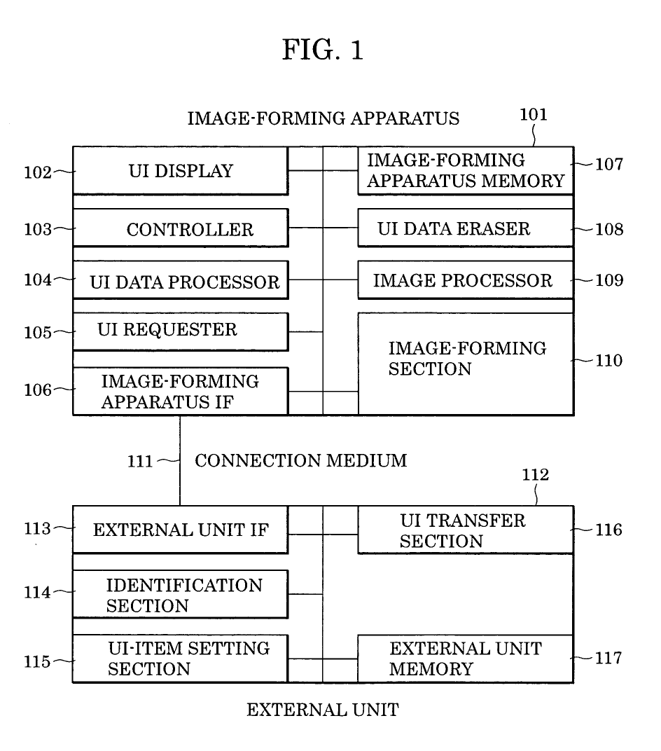

FIG. 1 is an overall view showing the structure of an image-forming system according to the first embodiment of the present invention. Although, in this case, the present invention is applied to a printer system, it is obvious that the present invention is applicable not only to printer systems and MFP systems but also to other systems that control data required for maintenance.

Referring to FIG. 1, an image-forming apparatus 101 mainly includes a UI display 102, a controller 103, a UI data processor 104, a UI requester 105, an image-forming apparatus interface (IF) 106, an image-forming apparatus memory 107, a UI data eraser 108, an image processor 109, and an image-forming section 110. The controller 103 controls overall data processing via an internal bus. In the present embodiment, the image-forming apparatus 101 may be described as a printer.

The UI display 102 is a so-called operation touch panel included in the printer and serves as an interface for the printer. Various settings for the printer can be performed and the operating conditions can be checked on the operation touch panel. The operating touch panel of the present embodiment is characterized in that it is capable of displaying menu items for maintenance, such as adjustments inside the printer. Although the operation touch panel generally used is a liquid crystal display (LCD), it may be any other display device that is capable of performing the same functions. In the present embodiment, the UI display 102 may be described as an operation touch panel.

When the controller 103 receives input from the UI display 102, that is, when a printer user operates the operation touch panel, the controller 103 instructs appropriate sections in the printer to operate and execute processing depending on the type of user operation. For example, when a menu item for outputting a test page of the printer is selected on the operation touch panel, the controller 103 instructs the image processor 109 to output a test page.

The UI data processor 104 interprets UI data (display components, such as display screen data, to be displayed on the UI display 102 serving as an operation section) transferred from an external unit 112, and displays a specific UI (which is equivalent to a UI screen and is also called an operation screen or a display screen) corresponding to the result of the interpretation, on the UI display 102.

The UI requester 105 communicates with the external unit 112 to request UI data, together with identification information for identifying the printer (image-forming apparatus 101). This UI data is for a UI screen to be displayed on the operation touch panel used for maintenance, such as adjustments of the printer. In the present embodiment, such UI data for an operation screen to carry out maintenance-related settings is controlled such that it is not always retained in an internal memory of the printer. The UI data is controlled so as not to be retained in the internal memory of the image-forming apparatus 101 except for the time when it is required.

For example, the UI data is controlled to be retained in the internal memory of the image-forming apparatus 101 at least during the time when an operator, such as an administrator operating the image-forming apparatus 101, carries out maintenance-related settings using the operation section of the image-forming apparatus 101. Then, the UI data is controlled so as not to be retained in the internal memory of the image-forming apparatus 101 except for this time period.

That is, a UI cannot be displayed until UI data corresponding to the UI is transferred from the external unit 112.

In the present embodiment, identification information is for identifying the printer itself and allows UI data specific to this printer to be transferred from the external unit 112.

This indicates that UI data transferred from the external unit 112 may differ from printer to printer, even in the same printer model.

A UI for maintenance allows for detailed adjustments in the printer, such as settings of fuser temperatures and the maximum amount of toner deposition in the image-forming section 110 that are unnecessary for general users.

In markets such as the POD market, UI items for such detailed printer adjustments, which are not normally open to general users, are required.

In the present embodiment, a UI for maintenance, such as printer adjustments, which is requested to be transferred from the external unit 112, may be described as a maintenance menu.

The image-forming apparatus IF 106 is an interface for connecting a connection medium 111 to the printer, and is configured to match the connection medium 111.

For example, if the connection medium 111 is Ethernet, the image-forming apparatus IF 106 is an Ethernet connector. If the connection medium 111 is a universal serial bus (USB), the image-forming apparatus IF 106 is a USB connector.

The image-forming apparatus memory 107 retains UI data transferred from the external unit 112. The image-forming apparatus memory 107 is a memory unit, such as a hard disk or a random access memory (RAM). In the present embodiment, the image-forming apparatus memory 107 is not limited to a volatile memory or nonvolatile memory, but may be any memory that is writable and erasable.

The UI data eraser 108 completely erases UI data transferred from the external unit 112 and stored in the image-forming apparatus memory 107. The UI data can be erased at any time, for example, at the instant when a menu for maintenance is terminated, or when nothing is entered on the operation touch panel for a certain period of time. When the UI transferred from the external unit 112, that is, a maintenance menu, is terminated, a normal UI prestored in the printer is displayed on the operation touch panel of the printer.

The image processor 109 analyzes a print job sent by a printer user via the connection medium 111 and creates bit-mapped data printable by the image-forming section 110. The image processor 109 generally analyzes, for example, page description language created by a printer driver to produce bit-mapped page data. A unit that performs such a function is called a raster image processor (RIP).

Then, the image-forming section 110 prints the bit-mapped data created by the image processor 109 onto a sheet of paper so as to obtain a printed output. Although an electrophotographic method is employed in the present embodiment, any image-forming method is applicable provided that a print job is executed to produce printed material.

The connection medium 111 is a connection medium for connecting the image-forming apparatus 101 to the external unit 112. The connection medium 111 may be, for example, Ethernet, a USB connection directly connected to a personal computer (PC), or a wireless transmission system connected to a PC via radio waves (Bluetooth™).

The present embodiment may be described on the assumption that the connection medium 111 is Ethernet, and the image-forming apparatus 101 is connected to the external unit 112 via the Internet.

The external unit 112 includes an external unit IF 113, an identification section 114, a UI-item setting section 115, a UI transfer section 116, and an external unit memory 117. A controller (not shown) is connected to each part via an internal bus to perform overall control.

This external unit 112 may be a general-purpose PC or a server, such as a file server or a web server.

That is, the external unit 112 may be any equipment provided that selects appropriate UI data in response to a UI request together with identification information from the printer, and transfers the UI data read out from the external unit memory 117 to the printer that has requested the UI data. In the present embodiment, the external unit 112 may be described as a UI server. The external unit 112 may be a general-purpose PC or a server, such as a file server or a web server.

The external unit IF 113 is an interface for connecting the connection medium 111 to the printer, and is configured to match the connection medium 111.

For example, if the connection medium 111 is Ethernet, the external unit IF 113 is an Ethernet connector. If the connection medium 111 is a universal serial bus (USB), the external unit IF 113 is a USB connector.

The identification section 114 analyzes the identification information, which is attached to the UI request from the UI requester 105, in order to identify the printer. The identification information is unique information to identify individual printers.

In the UI-item setting section 115, maintenance-related UI items to be displayed on the printer can be set for individual printers. The setting can be made only by an administrator having appropriate authority. The set contents are stored in the external unit memory 117.

For example, the administrator having authority to perform setting accesses a UI server (external unit 112) via the Internet so as to set permissions, in the UI-item setting section 115, for UI items to be displayed in individual printers.

According to this setting, UI data specific to the printer is transferred from the UI server to the printer, where the controller 103 performs control to display only UI items for which permission is granted.

In other words, UI items that are not permitted to be displayed, according to the setting performed in the external unit 112 by an authorized user, are never displayed on the printer, where no UI data corresponding to such UI items exists.

The UI transfer section 116 transfers UI data specific to the printer from the UI server to the printer, according to the setting made in the UI-item setting section 115 and stored in the external unit memory 117.

All UI data for maintenance, such as adjustment, used in each printer connectable to the UI server is stored in the external unit memory 117 so as to be updatable (by downloading from a manufacturer's management server (not shown) as required). This storing operation is performed only by an administrator having appropriate authority. Data set in the UI-item setting section 115 is also stored in the external unit memory 117.

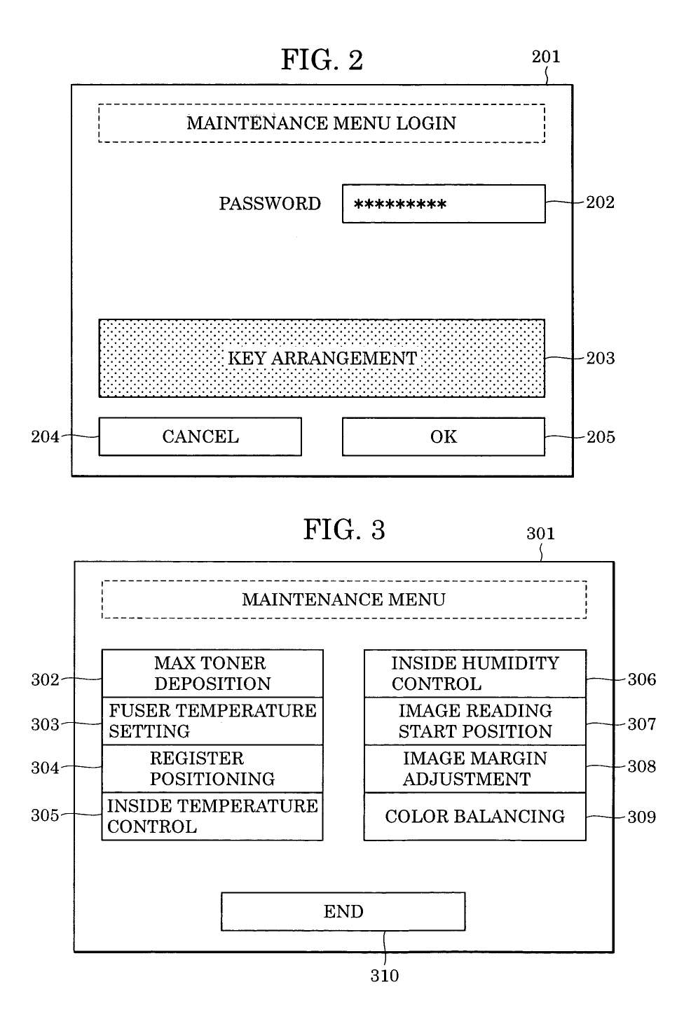

FIG. 2 is a diagram showing an example of an operation screen displayed on the UI display 102 in FIG. 1. FIG. 2 shows a login screen for entering a maintenance menu to be displayed on the operation touch panel.

Referring to FIG. 2, a maintenance-menu login screen 201 includes a password entry field 202, a key arrangement 203, a cancel button 204, and an OK button 205.

This screen is a login screen for allowing only users who know the password to enter the maintenance menu for performing a maintenance operation, such as adjustments. The maintenance-menu login screen 201 is prestored in the image-forming apparatus memory 107 in the printer, and is not transferred from the UI server. The maintenance-menu login screen 201 can be displayed by any users who select a menu item from a normal menu screen in each printer.

The password entry field 202 is for entering a password defined in each printer to log into the maintenance menu. The key arrangement 203 is used to enter the password. The password is defined by a printer administrator and set for each printer.

The key arrangement 203 is used for entry of passwords in the password entry field 202 and is configured to display a keyboard arrangement, such as alphabet keys and a numeric keypad.

The cancel button 204 is provided to cancel logging into the maintenance menu and return to the normal printer menu.

The OK button 205 is pressed after a password is entered in the password entry field 202 for executing a login procedure using the password actually entered. If the password entered is correct, the UI requester 105 sends a request for UI data to the UI server, together with identification information (stored in the image-forming apparatus memory 107) for the printer. Then, the UI data specific to this printer is transferred from the UI server to be displayed on the operation touch panel.

If the password entered is incorrect, the maintenance-menu login screen 201 is displayed on the operation touch panel again.

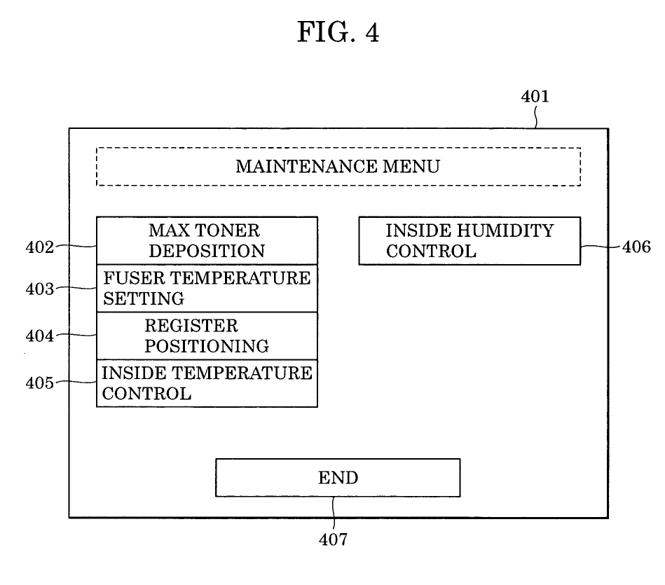

FIGS. 3 and 4 are diagrams showing examples of an operation screen displayed on the UI display 102 in FIG. 1. For example, a maintenance menu displayed on an operation touch panel for a printer A and a maintenance menu displayed on an operation touch panel for a printer B are shown in Fig. 3 and FIG. 4, respectively.

Referring to FIG. 3, a maintenance menu screen 301 includes maintenance menu items 302 to 309 and an end button 310.

The maintenance menu items 302 to 309, which are transferred from the UI server to the printer A, are specific to the printer A (menu items that are different depending on the printer identification information, even in the same printer model). When a user selects a desired item from the maintenance menu items displayed, display control is performed to cause a transition to a UI screen that displays more details of the selected item. No further description of screen display control will be given in the present embodiment.

The end button 310 is pressed, after the completion of maintenance, to exit the maintenance menu screen 301 currently logged in.

When the user presses the end button 310, the screen on which display control is performed returns to the normal menu screen, which is not transferred from the UI server, that is, which is prestored in the image-forming apparatus memory 107 in the printer A.

To reenter the maintenance menu screen 301 after pressing the end button 310, the user needs to enter the maintenance-menu login screen 201 from the normal menu screen, so as to log into the maintenance menu screen 301.

Display items that are different from those in FIG. 3 will now be described with reference to FIG. 4.

FIG. 4 (when compared to FIG. 3) illustrates that maintenance menu items displayed are different from printer to printer. FIG. 4 is an example of a maintenance menu displayed on an operation touch panel for the printer B.

Referring to FIG. 4, a maintenance menu screen 401 includes maintenance menu items 402 to 406 and an end button 407.

The maintenance menu items 402 to 406, which are specific to the printer B, are transferred from the UI server to the printer B, after the successful completion of user authentication and transfer of identification information for identifying the printer B.

When a user selects a desired item from the maintenance menu items displayed, display control is performed to cause a transition to a UI screen that displays more details of the selected item. No further description of the screen will be given in the present embodiment.

Further descriptions are provided next for the maintenance menu items displayed on the printer A shown in FIG. 3, and the maintenance menu items displayed on the printer B shown in FIG. 4.

The maintenance menu items 302 to 309 displayed on the maintenance menu screen 301 in FIG. 3 are different from the maintenance menu items 402 to 406 displayed on the maintenance menu screen 401 in FIG. 4.

Specifically, the maintenance menu screen 301 for the printer A includes three items, “image reading start position”, “image margin adjustment”, and “color balancing”, which are the maintenance menu items 307 to 309. However, no maintenance menu items corresponding to those listed above are included in the maintenance menu screen 401 for the printer B.

This indicates that UI items permitted or not permitted to be displayed in each printer are different depending on the setting in the UI-item setting section 115 in the UI server, and the setting is reflected in each printer.

That is, the printer A and the printer B display different menu items for maintenance, such as adjustments. To set menu items to be displayed in individual printers, an administrator with appropriate authority accesses the UI server, as described above, to perform setting in the UI-item setting section 115.

The end button 407 is pressed, after the completion of maintenance, to exit the maintenance menu screen 401 currently logged in. When the user presses the end button 407, the screen on which display control is performed returns to the normal menu screen, which is not transferred from the UI server, that is, which is prestored in the image-forming apparatus memory 107 in the printer B.

To reenter the maintenance menu screen 401 after pressing the end button 407, the user needs to enter the maintenance-menu login screen 201 from the normal menu screen, so as to log into the maintenance menu screen 401.

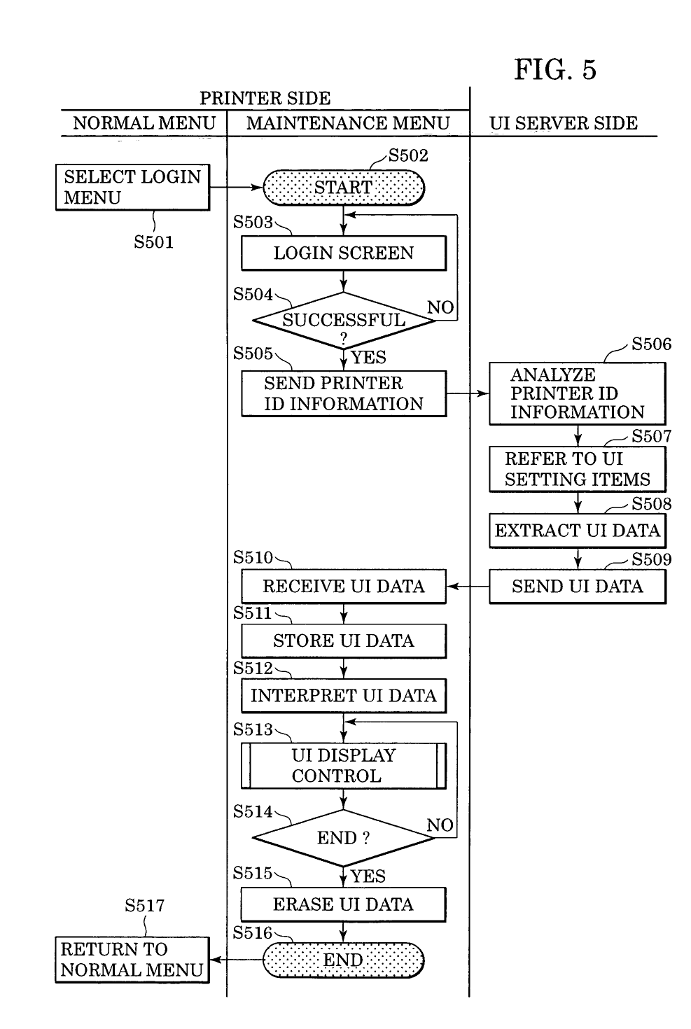

FIG. 5 is a flowchart showing an example of a first data processing procedure, which corresponds to a menu display procedure, in the image-forming system according to the present invention. Reference numerals S501 to S517 indicate steps in the procedure. Steps S506 to S509 are performed on the UI server side, and all of the other steps are performed on the printer side.

First, the login menu to enter the maintenance menu is selected from the normal menu normally displayed on the operation touch panel, which is the UI display 102 of the printer (S501). Then, processing of the maintenance menu starts (S502).

When the processing of the maintenance menu starts, the maintenance-menu login screen 201 in FIG. 2 appears. According to the operating procedure described above, the user enters a password set for the printer to log into the maintenance menu and presses the OK button 205 (S503). The maintenance-menu login screen 201 is not transferred from the UI server, but is prestored in the image-forming apparatus memory 107 inside the printer.

Then, it is determined whether or not the password entered in step S503 matches the password preset in order to determine whether or not the authentication was successful (S504). If it is determined that the password entered on the maintenance-menu login screen 201 is incorrect, the process returns to step S503 and the maintenance-menu login screen 201 is displayed.

On the other hand, if it is determined, in step S504, that the password entered on the maintenance-menu login screen 201 is correct (the authentication was successful), the process proceeds to step S505, where the UI requester 105 sends a UI request, together with identification information specific to the printer, to the UI server. The identification information is for uniquely identifying the printer.

The UI server analyzes, in the identification section 114, the printer identification information sent from the UI requester 105 to identify the printer from which the UI request is sent (S506).

The UI server then refers to data of printer-specific UI settings stored in the external unit memory 117 to determine the UI settings specific to the printer from which the UI request is sent (S507). In the UI settings, items permitted and not permitted to be displayed in this printer are specified and stored, for example, by setting flags ON/OFF.

Then, in the UI transfer section 116, the UI data specific to the printer from which the UI request is sent is extracted from the external unit memory 117 according to the UI settings, which are set in the UI-item setting section 115, that permit and prohibit the UI items to be displayed (S508).

The UI transfer section 116 transfers the extracted UI data to the printer from which the UI request is sent (S509). Although all the UI data is transferred at once in the present embodiment, the UI data may be transferred every time the printer sends a request in response to the change of the maintenance screen.

The printer receives the UI data transferred from the UI server (S510). The controller 103 then stores the received UI data in the image-forming apparatus memory 107 (S511).

The UI data processor 104 interprets the UI data stored in the image-forming apparatus memory 107 (S512) to control the menu items to be displayed on the operation touch panel.

On the operation touch panel, switching control is performed for displaying different menu items in each printer according to UI display instructions from the UI data processor 104, screens are changed in response to the user's operation, and instructions are transmitted to the controller 103, thus performing UI display control (S513).

Then, it is determined whether or not termination of the maintenance menu screen is requested by the user (S514). Control for displaying the maintenance menu UI continues (S513-S514 are repeated) until it is determined (in S514) that termination of the screen is requested.

If it is determined, in step S514, that termination is requested, the maintenance menu screen is completed and the process proceeds to step S515.

After the completion of the maintenance menu, the UI data eraser 108 erases all of the UI data transferred from the UI server and stored in the image-forming apparatus memory 107 (S515) to complete the maintenance menu processing (S516).

After the completion of the display control for the maintenance menu, switching control is performed to display the normal menu on the operation touch panel returning to the normal screen (S517). The entire procedure is thus completed.

In the image-forming system described above, a mechanism for pre-storing data related to the maintenance menu is not required on the printer side. Without designing a UI for each printer, menu items specific to each printer can be displayed on the shared UI menu screen.

Second Embodiment

Although the first embodiment is characterized in that displayed maintenance menu items are different from printer to printer, display of the maintenance menu UI may be changed depending on the combination of a printer and its user.

Specifically, to enter the maintenance menu, a unique ID for each user is required in addition to a password, as described in the first embodiment. Then, the identification information (password and user ID) and a UI request are sent to the UI server. Based on the identification information, the UI server identifies the combination of the printer from which the UI request is sent and its user, thus transferring the corresponding UI data to the printer.

In the second embodiment, a UI setting for each printer, which is stored in the UI server, includes a table that can be identified by a user name. The table specifies maintenance menu items permitted or not permitted to be carried out by each user for the printer. The following will only describe the differences from the first embodiment.

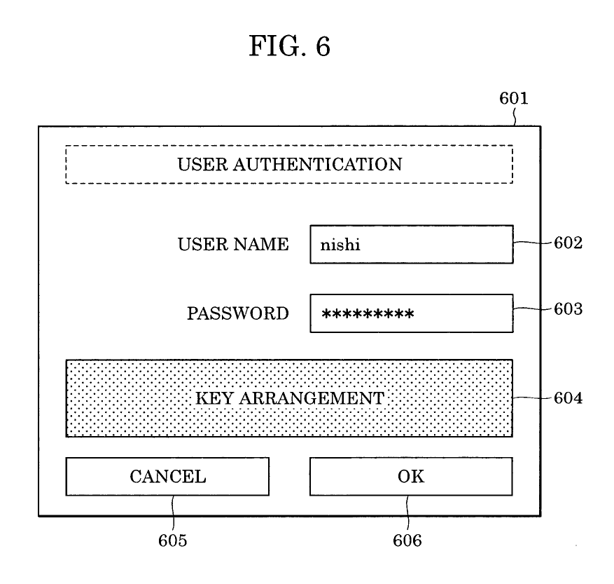

FIG. 6 is a diagram showing an example of a user authentication screen in an image-forming system of the second embodiment according to the present invention. FIG. 6 shows an example of the authentication screen to enter the maintenance menu to be displayed on the operation touch panel, which is the UI display 102 shown in FIG. 1.

Referring to FIG. 6, the user authentication screen 601 includes a user-name entry field 602, a password entry field 603, a key arrangement 604, a cancel button 605, and an OK button 606.

This screen is a user authentication screen for allowing only users whose user names and passwords are preset to enter the maintenance menu for performing maintenance, such as adjustments. The user authentication screen 601 is prestored in the image-forming apparatus memory 107 in the printer, and is not transferred from the UI server. The user authentication screen 601 can be displayed by any user who selects a menu item from a normal menu screen in each printer.

The user-name entry field 602 is for entering a user name defined for each user to log into the maintenance menu. The key arrangement 604 is used to enter the user name. The user name is defined by a printer administrator and set for each user.

The password entry field 603 is for entering a password defined for each user to log into the maintenance menu. The key arrangement 604 is used to enter the password. The password is defined by a printer administrator and set for each user.

The key arrangement 604 is used for entering user names and passwords in the user entry field 602 and password entry field 603, respectively, and displays a keyboard arrangement, such as alphabet keys and a numeric keypad.

The cancel button 605 is provided for the user to cancel logging into the maintenance menu and return to the normal printer menu.

The OK button 606 is pressed after a user name and password are entered in the user-name entry field 602 and password entry field 603, respectively, so as to execute a login procedure using the user name and the password actually entered.

If the UI requester 105 determines that the combination of the user name and password entered is correct, the UI requester 105 sends a request for UI data to the UI server, together with identification information for the user name and printer. Then, the UI data specific to this printer and user is transferred from the UI server to be displayed on the operation touch panel.

If the combination of the user name and password entered is incorrect, the screen display is controlled such that the user authentication screen 601 is displayed on the operation touch panel again.

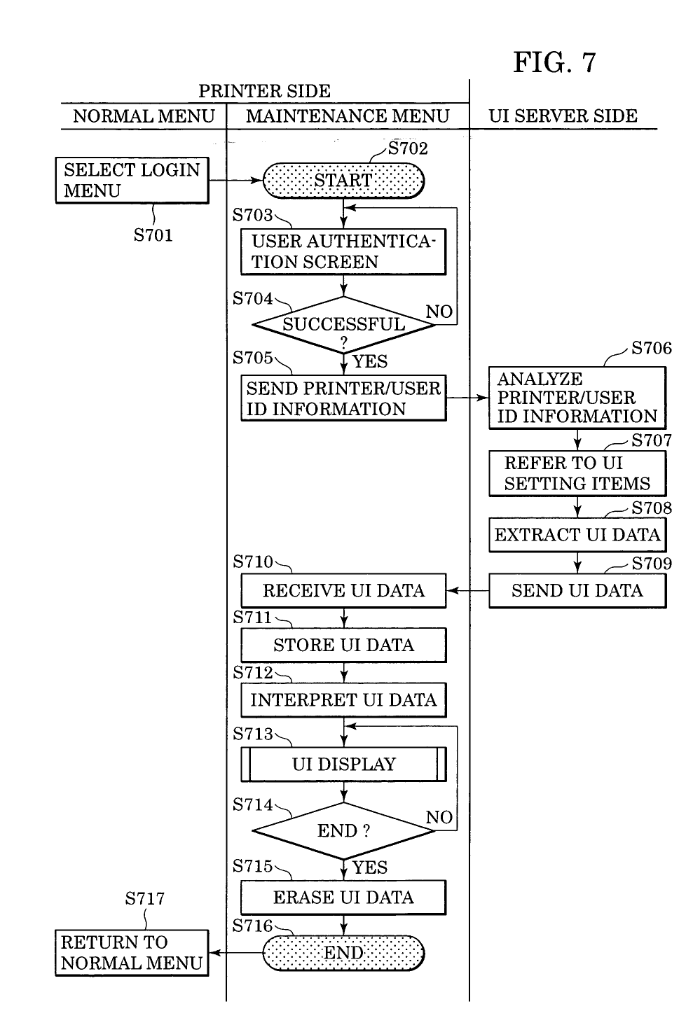

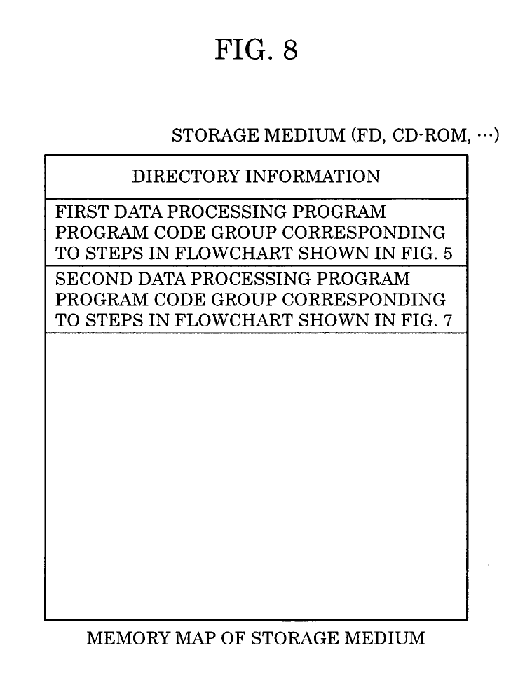

FIG. 7 is a flowchart showing an example of a second data processing procedure, which corresponds to a menu display procedure, in the image-forming system according to the present invention. Reference numerals S701 to S717 indicate steps in the procedure. Steps S706 to S709 are performed on the UI server side, are all of the other steps are performed on the printer side.

First, the login menu to enter the maintenance menu is selected from the normal menu normally displayed on the operation touch panel included in the UI display 102 of the printer (S701). Then, processing of the maintenance menu starts (S702).

When the processing of the maintenance menu starts, the user authentication screen 601 in FIG. 6 appears. According to the operating procedure described above, the user enters a user name and password set for the printer to log into the maintenance menu and presses the OK button 606 (S703).

The user authentication screen 601 shown in FIG. 6 is not transferred from the UI server, but is prestored in the image-forming apparatus memory 107 inside the printer.

Then, it is determined whether or not the user name and password entered in step S703 match any of the preset user name and password combinations, thus determining whether or not the authentication was successful (S704). If it is: determined that the user name and password combination entered on the user authentication screen 601 is incorrect, the process returns to step S703 and the user authentication screen 601 is displayed.

On the other hand, if it is determined, in step S704, that the user name and password combination entered on the user authentication screen 601 is correct (the authentication was successful), the process proceeds to step S705, where the UI requester 105 sends a UI request, together with identification information specific to the user and printer, to the UI server. The identification information is for uniquely identifying the combination of the user and printer.

The UI server analyzes, in the identification section 114, the user and printer identification information sent from the UI requester 105 so as to identify the printer from which the UI request is sent (S706).

The UI server then refers to data of printer-specific UI settings stored in the external unit memory 117 (S707) to determine the UI setting specific to the combination of the user and printer from which the UI request is sent. In the UI setting, items permitted and not permitted to be displayed for the combination of the user and printer are specified, stored, and maintained, for example, in a table.

Then, in the UI transfer section 116, the UI data specific to the combination of the user and printer from which the UI request is sent is extracted from the external unit memory 117, with reference to the above-described table or the like in the UI-item setting section 115, according to the UI setting that permits and prohibits the UI items to be displayed (S708).

The UI transfer section 116 transfers the extracted UI data to the printer from which the UI request is sent (S709).

Although all of the UI data is transferred at once in the present embodiment, the UI data may be transferred every time the printer sends a request in response to the change of the maintenance screen.

The printer receives the UI data transferred from the UI server (S710). The received UI data is stored in the image-forming apparatus memory 107 (S711).

The UI data processor 104 interprets the UI data stored in the image-forming apparatus memory 107 (S712) to control the display on the operation touch panel.

On the operation touch panel, switching control is performed according to UI display instructions from the UI data processor 104, screens are changed in response to the user's operation, and instructions are transmitted to the controller 103, thus performing UI display control (S713).

Then, it is determined whether or not termination of the maintenance menu screen is requested by the user (S714). Control for displaying the maintenance menu UI continues (S713-S714 are repeated) until it is determined (in S714) that termination of the screen is requested.

If it is determined, in step S714, that termination is requested, the maintenance menu screen is completed and the process proceeds to step S715.

After the completion of the maintenance menu, the UI data eraser 108 erases all the UI data transferred from the UI server and stored in the image-forming apparatus memory 107 (S715) to complete the maintenance menu processing (S716).

Finally, after the completion of the maintenance menu processing, control is performed to allow the normal printer menu, which is normally displayed, to be displayed on the operation touch screen, which is the UI display 102 (S717). The entire procedure is thus completed.

According to the embodiments described above, maintenance-related items, which are unnecessary or undesirable for many apparatuses and users, are not always displayed, but can be controlled to be displayed depending on the apparatus, or the combination of the apparatus and its user.

Since UI data is centrally controlled by the memory in the external unit, it is easily managed by apparatus manufacturers and system administrators for the apparatus users. Moreover, the UI provided by the image-forming system-can be unified.

Furthermore, since only a minimum amount of UI data for use in the image-forming apparatus is transferred from the external unit and is not permanently stored in the image-forming apparatus, prohibited maintenance items are never displayed, because no corresponding UI data exists in the image-forming apparatus. This is advantageous in terms of security.

Other Embodiments

In each embodiment described above, erasure of UI data transferred, for menu display, from the external unit 112 is described, for example, in step S515 shown in FIG. 5 and in step S715 shown in FIG. 7. Here, erasure modes, such as immediate erasure, time-limit erasure, and time-designated erasure may be provided such that erasure processing can be switched to any mode in response to the user's operation on the menu display.

This allows setting of the maintenance menu to be performed again, even after the completion thereof, by directly calling up UI data in the image-forming apparatus memory 107 without communicating with the external unit 112 as described above. Authentication processing is required in this case.

Moreover, to download UI data from the external unit 112 together with UI data temporarily stored in the image-forming apparatus memory 107, only the difference between both UI data needs to be obtained.

Furthermore, for example, version information, which is part of the UI data, may be stored and maintained without erasing it such that, through communication between the external unit 112 and the image-forming apparatus 110, it can be automatically determined whether or not the latest UI data should be downloaded, or such that the UI data can be automatically updated.

In step S515 shown in FIG. 5 or step S715 shown in FIG. 7, the following control is performed to erase the UI data provided by the external unit 112, from the image-forming apparatus memory 107.

That is, in the present embodiment, when an operator (for example, an administrator) completes maintenance-related setting, which is performed on the operation screen generated based on the UI data supplied from the external unit 112 to the operation section of the image-forming apparatus 110, the controller 103 of the image-forming apparatus 110 detects the completion, based on information, for example, from a sensor in the operation section, and performs control to automatically (without interruption and instructions from the operator) erase the UI data from the image-forming apparatus memory 107.

Thus, in the present embodiment, the controller 103 controls the image-forming apparatus memory 107 to automatically erase the UI data, based on the above-described determination (in response to the completion of the maintenance-related setting), without the operator's explicit instructions through the operation section of the image-forming apparatus 110.

The present embodiment may also be configured as follows. For example, in step S514 or step S714, in response to the completion of the maintenance-related setting, an operation screen showing a message may be displayed on the UI display 102 so as to ask the operator whether or not the UI data should be erased from the memory. Then, the memory may be controlled to erase the UI data in response to the instructions from the operator through the input on the operation screen. The present embodiment may thus be configured such that the UI data is erased in response to the explicit instructions from the operator.

The present embodiment may be configured in any way, provided that it has at least the following structure. For example, a specific setting for a specific apparatus, such as a setting for maintenance in the image-forming apparatus, can be performed, through a specific display, in the image-forming apparatus. Based on such a structure, the image-forming apparatus obtains specific information, such as UI data required for the specific display, from the external unit. Then the information obtained by the image-forming apparatus is stored in a memory thereof. The specific display is thus performed by the operation section of the image-forming apparatus based on the information stored in the memory. Then, the specific setting is controlled, through the display, such that it can be performed by an operator. For the specific setting, based on such a structure, control is performed for allowing the information to be stored in the memory of the image-forming apparatus, while prohibiting (preventing) the information from remaining in the memory of the image-forming apparatus during the time when the specific setting is not performed.

Specifically, for example, the image-forming system is controlled such that, every time the specific setting is performed in the image-forming apparatus, a request for the UI data is sent from the image-forming apparatus to the external unit; UI data specific to the image-forming apparatus is sent back to the apparatus in response to the request; the UI data is stored in the memory of the image-forming apparatus; and the specific display is performed in the image-forming apparatus based on the UI data stored, thus performing the specific setting through the specific display. Moreover, based on such a structure, the control section of the image-forming apparatus performs control, every time the specific setting is completed, such that the UI data temporarily stored in the memory of the image-forming apparatus is erased.

On the other hand, the control section of the image-forming apparatus allows display data used for other settings (including a setting, such as that described above, executable through the normal printer menu) different from the above-described specific setting to be prestored in the memory of the image-forming apparatus, without being obtained from the external unit. To perform settings other than the specific setting, display based on the display data prestored in the memory is performed by the control section of the image-forming apparatus, such that the operator can perform a desired setting through the display. In this structure UI data for the setting is allowed to remain in the memory of the image-forming apparatus even during the time when the setting is not performed.

To erase UI data in the present embodiment, any of the following erasure methods can be used. For example, without erasing actual UI data stored in the memory, control address data for reading the UI data can be overwritten such that the UI data cannot be read out from the memory. Alternatively, actual UI data itself can be overwritten such that the UI data cannot be read out from the memory. Other erasure methods can also be used provided that they can at least prohibit the UI data from being accidentally read out from the memory of the image-forming apparatus during the time when the specific setting described above is not performed.

The structure of a data processing program that can be read by the image-forming system of the present invention is described next with reference to a memory map shown in FIG. 8.

FIG. 8 is a diagram illustrating a memory map of a storage medium storing a variety of data processing programs readable by the image-forming system according to the present invention.

While not specifically shown, information, such as version information and creator names, for managing program groups stored in the storage medium is stored. Moreover, information, such as icons for identification of programs, dependent on the operating system (OS) reading the programs may be stored.

Data dependent on various programs is stored in the directory where the programs are stored. Moreover, programs for installing various programs on a computer and programs for decompressing compressed programs to be installed may also be stored.

The functions shown in FIGS. 5 and 7, in the present embodiment, may be performed by a host computer using programs externally installed. In this case, the present invention is also applicable even where groups of information, including programs, are supplied by a storage medium, such as a CD-ROM (compact disk-read-only memory), a flash memory, a floppy disk; or an external storage medium via a network.

A storage medium may be supplied for storing software program code for performing the functions of the above-described embodiments to the system or apparatus such that the computer (or CPU (central processing unit) or MPU (micro-processing unit)) thereof reads out and executes the program code stored in the storage medium.

In this case, the program code read out from the storage medium performs the novel functions of the present invention and the storage medium storing the program code constitutes the present invention.

Therefore, the program may take any form, such as one executed by object code and interpreters, or script data to be supplied to the OS, as long as it serves as a program.

The storage medium supplying programs may be, for example, a flexible disk, a hard disk, an optical disk, a magneto-optical (MO) disk, a CD-ROM, a CD-R (compact disk-recordable), a CD-RW (compact disk-rewritable), a magnetic tape, a non-volatile memory card, a ROM, and a DVD (digital versatile disk).

In this case, the program code read out from the recording medium performs the functions of the above-described embodiments and the storage medium storing the program code constitutes the present invention.

The programs can also be supplied by accessing a homepage on the Internet using a browser on a client computer and downloading a computer program of the present invention or compressed file with an auto-install function into a recording medium, such as a hard disk. Alternatively, the program can also be supplied by dividing program code constituting the present invention into a plurality of files and downloading each file from different homepages. Therefore, for example, a WWW (world wide web) server and an ftp (file transfer protocol) server that allow a plurality of users to download program files for computers to perform functions of the present invention are also included in aspects of the present invention.

The program can also be provided by encrypting the program of the present invention, storing it in a storage medium, such as a CD-ROM, distributing it to users, allowing users meeting predetermined conditions to download, from a homepage via the Internet, key information for decrypting the encrypted program, and allowing the users to use the key information for executing the encrypted program and installing it into the computer.

The functions of the above-described embodiments can also be performed not only by a computer reading out and executing program code, but also by an OS (operating system) running on the computer and executing a whole or part of the actual processing in accordance with instructions of the program code.

The functions of the above-described embodiments can also be performed, after program code read out from a storage medium is written in a memory of a function expansion board in a computer or an expansion unit connected to a computer, by a CPU or the like included in the function expansion board or expansion unit and executing a whole or part of the actual processing in accordance with instructions of the program code.

The present invention is not limited to the disclosed embodiments. On the contrary, the invention is intended to cover various modifications (including the organic combination of the embodiments) included within the spirit and scope of the invention.

While the present invention has been described with reference to various examples and embodiments, the spirit and scope of the invention, for those skilled in the art, are not-limited to the particular descriptions in the present specification.

As described above, the problems in known techniques can be prevented by the present embodiment. For example, there is no need for the image-forming apparatus to store specific UI data required for controlling it, and specific UI data can be displayed on the display only when requested by a specific operator who needs to control the specific UI data. Moreover, the specific UI data can be erased in a timely manner so as not to be viewed by general users. Both convenience and security can thus be achieved.

The present invention is not limited to the embodiments described above, but various modifications can be made without departing from the scope of the present invention.

This application claims priority from Japanese Patent Application No. 2003-404291 filed Dec. 3, 2003, which is hereby incorporated by reference herein.

1. An image-forming system in which at least one image-forming apparatus is connected to an external unit, via a network, such that they can communicate with one another, each image-forming apparatus comprising:
first user interface control means for displaying a local user interface on a display, based on local user interface data used for a setting required for predetermined image-forming processing; and
second user interface control means for sending a user interface request for specific user interface data together with identification information for identifying the image-forming apparatus to the external unit, and generating and displaying an individual user interface on the display, based on the specific user interface data obtained from the external unit, the external unit comprising:
storing means for storing specific user interface data specific to each image-forming apparatus to uniquely identify each image-forming apparatus; and
user interface data processing means for identifying the image-forming apparatus from which the user interface request is sent, extracting, from the storing means, the specific user interface data for the image-forming apparatus identified, and sending the specific user interface data for the image-forming apparatus to the image-forming apparatus requesting the specific user interface data.

2. The image-forming system according to claim 1, wherein the second user interface control means erases the specific user interface data obtained from the external unit at a timing based on user settings.

3. The image-forming system according to claim 1, wherein the second user interface control means further performs a user authentication and sends the request for specific user interface data to the external unit based on a result of the user authentication.

4. The image-forming system according to claim 1, wherein the specific user interface data is user interface data required for maintenance setting and is set for identification of individual image-forming apparatuses.

5. The image-forming system according to claim 1, wherein the identification information includes a user ID and a password that are entered on a user interface.

6. The image-forming system according to claim 1, wherein the storing means does not store specific user interface data transferred from the external unit.

7. The image-forming system according to claim 1, wherein the UI data processing means identifies the image-forming apparatus and its user based on the identification information sent from the second user interface control means.

8. The image-forming system according to claim 1, wherein specific user interface data for each image-forming apparatus is set and stored in the storing means based on instructions of an administrator from a specific data processing unit.

9. A display-control method in an image-forming system in which at least one image-forming apparatus is connected to an external unit including storing means for storing user interface data specific to each image-forming apparatus so as to be identifiable, via a network, such that they can communicate with one another, the display-control method comprising:
displaying a local user interface on a display, based on local user interface data used for a setting required for predetermined image-forming processing;
sending a request for specific user interface data together with identification information for identifying the image-forming apparatus to the external unit;
generating and displaying an individual user interface on the display, based on the specific user interface data obtained from the external unit;
identifying the image-forming apparatus from which a user interface request is sent;
extracting the specific user interface data identified; and
sending the specific user interface data to the image-forming apparatus requesting the specific user interface data.

10. The display-control method according to claim 9, further comprising erasing the specific user interface data obtained from the external unit at a timing based on user settings.

11. The display-control method according to claim 9, wherein sending a request for specific user interface data comprises sending the request for specific user interface data to the external unit, depending on a result of authentication.

12. The display-control method according to claim 9, wherein the specific user interface data is user interface data required for maintenance setting and is identifiably set for individual image-forming apparatuses.

13. The display-control method according to claim 9, wherein the identification information includes a user ID and password that are entered on a user interface.

14. The display-control method according to claim 9, wherein, both the image-forming apparatus and its user are identified based on identification information sent.

15. The display-control method according to claim 9, wherein specific user interface data for each image-forming apparatus is set and stored based on instructions of an administrator from a specific data processing unit.

16. A computer-readable storage medium storing a program for executing the display-control method according to claim 9.

17. A control method in a system having a second device capable of receiving data from a first device, the control method comprising:
allowing information output from the first device and required for performing a specific setting related to the second device to be stored in a storage unit; and
making the specific setting executable based on the information in the storage unit;
wherein the information is prohibited from remaining in the storage unit while the specific setting is not performed.

18. The control method according to claim 17, further comprising:
allowing second information required for performing a second setting different from the specific setting to be stored in the storage unit; and
making the second setting executable based on the second information in the storage unit;
wherein the second information is allowed to remain in the storage unit while the second setting is not performed.

19. The control method according to claim 18, wherein
the second device includes an image-forming apparatus;
the specific setting includes a specific setting for the image-forming apparatus; and
the second setting includes a setting other than the specific setting for the image-forming apparatus.

20. The control method according to claim 19, wherein
the specific setting includes a maintenance setting for the image-forming apparatus; and
the second setting includes a setting other than the maintenance setting for the image-forming apparatus.

21. The control method according to claim 19, wherein
the specific setting includes a setting other than a normal print setting for the image-forming apparatus; and
the second setting includes the normal print setting for the image-forming apparatus.

22. The control method according to claim 17, further comprising erasing the information in the storage unit while the specific setting is not performed.

23. The control method according to claim 22, wherein the information from the external unit is allowed to be stored in the storage unit every time the specific setting is performed, and the information in the storage unit is allowed to be erased every time the specific setting is completed.

24. The control method according to claim 22, wherein the storage unit is allowed to erase the information in response to execution of the specific setting by an operator, without any explicit erasing instructions from the operator.

25. The control method according to claim 24, wherein the storage unit is allowed to erase the information in accordance with erasing instructions input by the operator after the execution of specific setting by the operator.

26. The control method according to claim 17, wherein the storage unit is included in the first device.

27. A computer-readable storage medium storing a program enabling a system having a second device capable of receiving data from a first device to execute steps according to the method recited in claim 17.

28. A system having a second device capable of receiving data from a first device, the system comprising:
a storage controller adapted to allow information to be stored in a storage unit, the information being output from the first device and required for performing a specific setting related to the second device; and
a setting controller adapted to make the specific setting executable based on the information in the storage unit;
wherein the information is prohibited from remaining in the storage unit while the specific setting is not performed.

29. A system including an information processor and a plurality of image-forming apparatuses capable of performing data communication with the information processor, each image-forming apparatus comprising:
a storage unit;
an information requesting unit adapted to send a request for information necessary for performing a specific setting to the information processor;
an information receptor adapted to receive the information output from the information processor in response to the request;
a storage controller adapted to allow the received information to be stored in the storage unit; and
a setting controller adapted to make the specific setting executable based on the information in the storage unit;
wherein the storage controller prohibits the information from remaining in the storage unit while the specific setting is not performed.

30. A method in a system including an information processor and a plurality of image-forming apparatuses capable of performing data communication with the information processor, the method enabling the plurality of image-forming apparatuses to execute steps comprising:
sending a request for information necessary for performing a specific setting to the information processor;
receiving the information output from the information processor in response to the request;
allowing the received information to be stored in a storage unit of each image-forming apparatus; and
making the specific setting executable based on the information in the storage unit;
wherein the information is prohibited from remaining in the storage unit while the specific setting is not performed.
